(19) United States
(12) Patent Application Publication
(10) Pub. No.: US 2024/0330645 A1
(43) Pub. Date: Oct. 3, 2024

(54) SYSTEM AND METHOD FOR COGNITIVE NEURO-SYMBOLIC REASONING SYSTEMS

(71) Applicant: Robert Bosch GmbH, Stuttgart (DE)

(72) Inventor: Alessandro OLTRAMARI, Pittsburgh, PA (US)

(21) Appl. No.: 18/128,073

(22) Filed: Mar. 29, 2023

(51) Int. Cl. G06N 3/042; G06N 5/02; G06N 5/04

(52) U.S. Cl. CPC G06N 3/042; G06N 5/02; G06N 5/04

(57) ABSTRACT

A computer-implemented method includes receiving, at a neural network, input data indicating at least video data and natural language data, in response to meeting a convergence threshold of the neural network utilizing the input data, outputting one or more patterns associated with the input data to a cognitive architecture, wherein the cognitive architecture is in communication with a symbolic framework that includes a knowledge graph database and the symbolic framework is configured to identify contextual information of the one or more patterns received from the neural network utilizing at least the knowledge graph database, in response to the symbolic framework communicating the contextual information with the neural network, embedding the neural network with the contextual information of the knowledge graph dataset and outputting a recommendation indicating information associated with at least the input data utilizing an embedded neural network.

### TECHNICAL FIELD

The present disclosure relates to a machine learning network, including a machine learning network associated with reasoning systems or cognitive architectures.

### BACKGROUND

Knowledge-infusion methods are key to enhance neural models and improve their performance, but they are not sufficient to enable high-level reasoning, which may be typically required by tasks such as natural language understanding, activity recognition, decision making in complex scenarios.

A large part of neuro-symbolic systems is based on transforming symbolic knowledge into sub-symbolic representations that are suitable for learning algorithms. For instance, Knowledge Graph Embedding (KGE) is a prominent approach to reduce knowledge graph (KG) triples to latent vectors. Such transformation may be instrumental to efficient computability of KG properties, as well as to application in a variety of downstream tasks. Whether the KGE process is realized by geometric, tensor or deep learning models, the purpose is to compress KG structures into a low-dimensional space, where symbolic statements are replaced by dense, sub-symbolic expressions. Furthermore, concatenation, non-linear mapping, attention-like mechanisms, gating mechanisms, are additional methods used to adapt knowledge structures to neural computations.

While these knowledge-infusion methods are key to enhance neural models and improve their performance, they are not sufficient to enable high level reasoning, which is typically required by tasks such as natural language understanding, activity recognition, decision making in complex scenarios.

### SUMMARY

According to a first embodiment, a computer-implemented method includes receiving, at a neural network, input data indicating at least video data, audio data, and natural language data, in response to meeting a convergence threshold of the neural network utilizing the input data, outputting one or more patterns associated with the input data to a cognitive architecture including procedural memory and declarative memory, wherein the cognitive architecture is in communication with a symbolic framework that includes a knowledge graph database, wherein the symbolic framework is configured to identify contextual information of the one or more patterns utilizing at least the knowledge graph database, and in response to the symbolic framework communicating the contextual information with the neural network, embedding of the neural network with the contextual information of the knowledge graph dataset and outputting a recommendation indicating information associated with at least the input data utilizing an embedded neural network.

According to a second embodiment, a computer-implemented method includes receiving, at a neural network, input data indicating at least video data and natural language data, in response to meeting a convergence threshold of the neural network utilizing the input data, outputting one or more patterns associated with the input data to a cognitive architecture, wherein the cognitive architecture is in communication with a symbolic framework that includes a knowledge graph database and the symbolic framework is configured to identify contextual information of the one or more patterns received from the neural network utilizing at least the knowledge graph database, in response to the symbolic framework communicating the contextual information with the neural network, embedding the neural network with the contextual information of the knowledge graph dataset and outputting a recommendation indicating information associated with at least the input data utilizing an embedded neural network.

According to a third embodiment, a system includes a neural network, a cognitive architecture, and a symbolic framework. The system further includes one or more processors, wherein the processor is programmed to receive, at the neural network, input data indicating at least video data, audio data, and natural language data, in response to meeting a convergence threshold of the neural network utilizing the input data, output one or more patterns associated with the input data to the cognitive architecture including procedural memory and declarative memory, wherein the cognitive architecture is in communication with the symbolic framework that includes a knowledge graph database, wherein the symbolic framework is configured to identify contextual information of the one or more patterns utilizing at least the knowledge graph database, and in response to the symbolic framework communicating the contextual information with the neural network, embedding of the neural network with the contextual information of the knowledge graph dataset and outputting a recommendation indicating information associated with at least the input data utilizing an embedded neural network.

### BRIEF DESCRIPTION OF THE DRAWINGS

FIG. 1 shows a system for training a neural network.

FIG. 2 depicts a data annotation system to implement a system for annotating data.

FIG. 3 discloses an overview system architecture diagram of an embodiment utilizing a cognitive neuro-symbolic reasoning framework.

FIG. 4 is an embodiment of a flow chart of processing input to obtain an output utilizing a system according to one embodiment.

FIG. 5 depicts a schematic diagram of an interaction between computer-controlled machine and control system.

FIG. 6 depicts a schematic diagram of the control system configured to control a vehicle, which may be a partially autonomous vehicle or a partially autonomous robot.

FIG. 7 depicts a schematic diagram of the control system configured to control a manufacturing machine, such as a punch cutter, a cutter or a gun drill, of manufacturing system, such as part of a production line.

FIG. 8 depicts a schematic diagram of the control system configured to control a power tool, such as a power drill or driver, that has an at least partially autonomous mode.

FIG. 9 depicts a schematic diagram of the control system configured to control an automated personal assistant.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Over the last decade, the integration of deep learning in computer vision systems has yielded substantial advancements. For instance, neural models can achieve good performance in object detection when training and testing domains originate from the same data distribution. However, minimal/regional modifications implanted in the data at test time may cause significant drop in accuracy. Common sense contextualization, such as by means of incorporating a priori structured knowledge into deep models, can mitigate the effect of those perturbations, resulting in more robust performance. In general, a visual model suitably infused with knowledge extracted from semantic resources like ConceptNet can strengthen the connections holding within instances of the same conceptual domain (e.g., couch, television, table, lamp are located in living rooms) and discard out-of-context interpretations (e.g., no real elephants are located in living rooms, but photographs of elephant may be found).

When shifting to the language domain, and to tasks like automated question answering, the key role played by knowledge-based contextualization remains evident. For instance, it has been demonstrated that using KG triples to disambiguate textual elements in a sentence, and embed the corresponding concepts and relations in large language models, may significantly improve performance. In fact, despite of the impressive results that Neural Language Modeling (NLM) is producing in Natural Language Processing (NLP), basic reasoning capabilities are still largely missing. For example, in ProtoQA, GPT-3 fails to select options like ‘pumpkin’, ‘cauliflower’, ‘cabbage’ as top candidates, for the question ‘one vegetable that is about as big as your head is?’: instead, ‘broccoli’, ‘cucumber’, ‘beet’, ‘carrot’ are predicted. In this case, the different models learn some essential properties of vegetables from the training data, but do not seem to acquire the capability of comparing their size to that of other types of objects, revealing a substantial lack of analogical reasoning. The same issues may be observed when ChatGPT-3, a recent popular version of GPT-3 optimized for conversations, is considered. For example, the main difference is that ChatGPT-3 is capable of generating plausible answers only when the question is submitted literally, but fails to do so when the question is paraphrased by using synonyms of the verbal form ‘about as big as’, e.g., ‘about the same size’, ‘about the same shape’, ‘comparable to’, etc. This hypersensitivity to surface-level linguistic features (vocabulary, syntax, etc.)—a proxy of the model's incapability to generalize over textual variations of the same conceptual content-seem to indicate that the model cannot perform the necessary (analogical) reasoning steps needed to answer to the question correctly. Along these lines, such examples may have a lack of complex inferences, role-based event prediction, and understanding the conceptual impact of negation, are some of the weaknesses diagnosed when BERT, one of prominent open source language models, is applied to benchmark datasets. ProtoQA again provides good examples of these deficiencies: in general, neural models struggle to correctly interpret the scope of modifiers like ‘not’ (reasoning under negation), ‘often’ and ‘seldom’ (temporal reasoning). A comprehensive benchmark challenge designed by Facebook Research, NLM systems exhibit variable accuracy in grasping temporal ordering entailed by prepositions like ‘before’ and ‘after’. Similarly, NLM systems fail to infer basic positional information that require interpreting the semantics of ‘to the left/right of’, ‘above/below’, etc. If NLM systems are inaccurate when dealing with common characteristics of the physical world, their performance doesn't improve when sentiments are considered: for instance, in SocialIQA, given a context like ‘in the school play, Robin played a hero in the struggle to death with the angry villain’, models are unable to consistently select ‘hopeful that Robin will succeed’ over ‘sorry for the villain’ when required to pick the correct answer to ‘how would others feel afterwards?’. It's not surprising that reasoning about emotional reactions represents a difficult task for pure learning systems, when considering that such form of inference is deeply rooted in the sphere of human experiences and social life, which involves a ‘layered’ understanding of mental attitudes, intentions, motivations, empathy.

The system proposed to adopt a cognitive architecture as a framework to combine knowledge representation and reasoning with machine learning. The cognitive architecture may be an orchestrator of the integration between symbolic knowledge and machine learning. One example of a cognitive architecture may include ACT-R or other hybrid cognitive architectures. Such a system may overcome the issues described above.

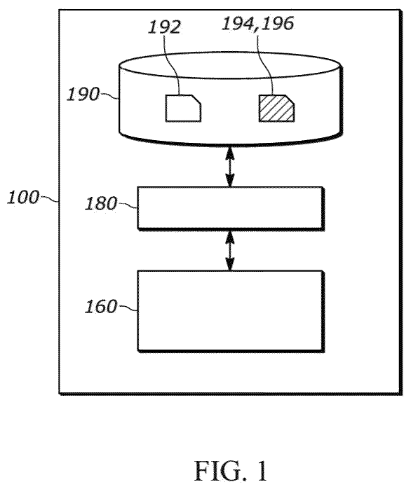

FIG. 1 shows a system 100 for training a neural network. The system 100 may comprise an input interface for accessing training data 192 for the neural network. For example, as illustrated in FIG. 1, the input interface may be constituted by a data storage interface 180 which may access the training data 192 from a data storage 190. For example, the data storage interface 180 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 190 may be an internal data storage of the system 100, such as a hard drive or SSD, but also an external data storage, e.g., a network-accessible data storage.

In some embodiments, the data storage 190 may further comprise a data representation 194 of an untrained version of the neural network which may be accessed by the system 100 from the data storage 190. It will be appreciated, however, that the training data 192 and the data representation 194 of the untrained neural network may also each be accessed from a different data storage, e.g., via a different subsystem of the data storage interface 180. Each subsystem may be of a type as is described above for the data storage interface 180. In other embodiments, the data representation 194 of the untrained neural network may be internally generated by the system 100 on the basis of design parameters for the neural network, and therefore may not explicitly be stored on the data storage 190. The system 100 may further comprise a processor subsystem 160 which may be configured to, during operation of the system 100, provide an iterative function as a substitute for a stack of layers of the neural network to be trained. In one embodiment, respective layers of the stack of layers being substituted may have mutually shared weights and may receive, as input, an output of a previous layer, or for a first layer of the stack of layers, an initial activation, and a part of the input of the stack of layers. The system may also include multiple layers. The processor subsystem 160 may be further configured to iteratively train the neural network using the training data 192. Here, an iteration of the training by the processor subsystem 160 may comprise a forward propagation part and a backward propagation part. The processor subsystem 160 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 196 of the trained neural network, this data may also be referred to as trained model data 196. For example, as also illustrated in FIG. 1, the output interface may be constituted by the data storage interface 180, with said interface being in these embodiments an input/output (“IO”) interface, via which the trained model data 196 may be stored in the data storage 190. For example, the data representation 194 defining the ‘untrained’ neural network may during or after the training be replaced, at least in part by the data representation 196 of the trained neural network, in that the parameters of the neural network, such as weights, hyper parameters and other types of parameters of neural networks, may be adapted to reflect the training on the training data 192. This is also illustrated in FIG. 1 by the reference numerals 194, 196 referring to the same data record on the data storage 190. In other embodiments, the data representation 196 may be stored separately from the data representation 194 defining the ‘untrained’ neural network. In some embodiments, the output interface may be separate from the data storage interface 180, but may in general be of a type as described above for the data storage interface 180.

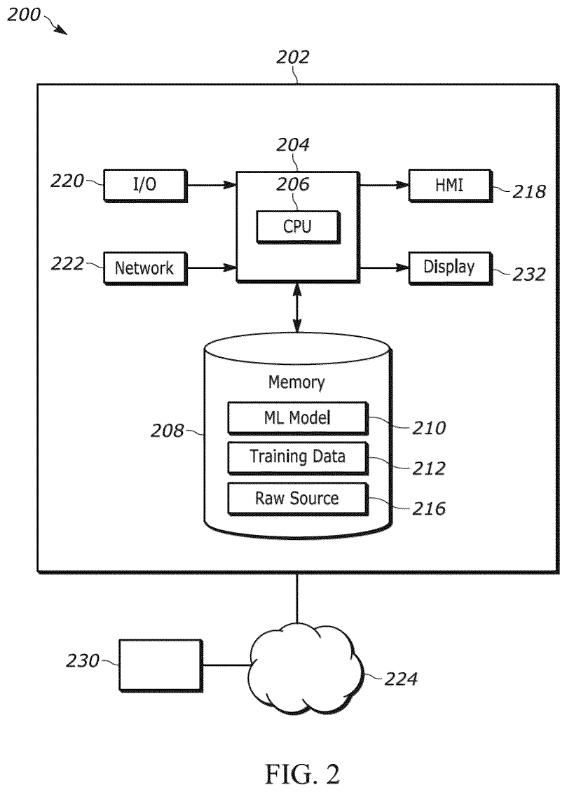

FIG. 2 depicts a data annotation system 200 to implement a system for annotating data. The data annotation system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 215.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 215. The raw source dataset 215 may include raw or unprocessed sensor data that may be representative of an input dataset for a machine-learning system. The raw source dataset 215 may include video, video segments, images, text-based information, and raw or partially processed sensor data (e.g., radar map of objects). In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 215. The raw source data 215 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 215 to identify the presence of the particular features. The machine-learning algorithm 210 may be configured to identify a feature in the raw source data 215 as a predetermined feature (e.g., pedestrian). The raw source data 215 may be derived from a variety of sources. For example, the raw source data 215 may be actual input data collected by a machine-learning system. The raw source data 215 may be machine generated for testing the system. As an example, the raw source data 215 may include raw video images from a camera.

In the example, the machine-learning algorithm 210 may process raw source data 215 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present.

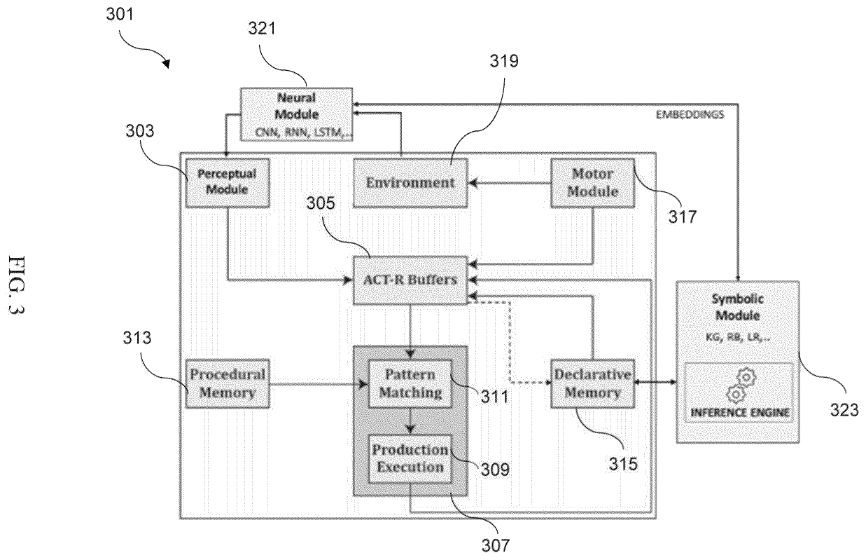

FIG. 3 discloses an overview system architecture diagram of an embodiment utilizing a cognitive neuro-symbolic reasoning framework. Cognitive architectures attempt to capture at the computational level the invariant mechanisms of human cognition, including those underlying the functions of control, learning, memory, adaptively, perception and action, which may be described as ACT-R. ACT-R (Adaptive Control of Thought, Rational), in particular, may be designed as a modular framework including perceptual module 303, motor module 317 and memory components (e.g., procedural memory 313 and declarative memory 315), synchronized by a procedural module 303 through limited capacity buffers (e.g. ACT-R buffers 305).

ACT-R may be a production system that tries to explain human cognition by developing a model of the knowledge structures that underlie cognition. There may be two types of knowledge representation in ACT-R—declarative knowledge and procedural knowledge. Declarative knowledge may correspond to things that a human may be aware of that can be known and can usually describe to others. Examples of declarative knowledge may include “George Washington was the first president of the United States” and “An atom is like the solar system”. Procedural knowledge may be knowledge which we display in our behavior but which we are not conscious of. For example, procedural knowledge may be the fact that it is difficult to describe the rules by which we speak a language, and but yet a human does speak a language. In ACT-R system, declarative knowledge may be represented in structures called chunks whereas procedural knowledge is represented in productions. Thus chunks and productions may be basic building blocks of an ACT-R model.

ACT-R has accounted for a broad range of tasks at a high level of fidelity, reproducing aspects of complex human behavior, from everyday activities like event planning and car driving, to highly technical tasks such as piloting an airplane, and monitoring a network to prevent cyber-attacks. In previous work, ACT-R has been used as a component in pipelines that include either learning algorithms (e.g., biologically-inspired neural networks) or external knowledge. However, there is no system and method that exists, however, to intertwine the cognitive architecture (e.g., ACT-R system 301) with neuro-symbolic methods and structures. As such, an extension may instrumental to enhance AI-systems and enable high-level reasoning.

The basic ACT-R system 301 may include various compensated or sub-components. For example, system 301 may include a perceptual module 303 that communicates with buffers 305. The ACT-R framework may include a production system 307 that includes a pattern matching module 311 and a production execution module 309. The buffers 305 may be the interface between the procedural memory system 313 and the other components (modules) of the ACT-R architecture. For instance in one example, a goal buffer may be an interface to the goal module. Each buffer 305 may hold one chunk at a time, and the actions of a production 309 may affect the contents of the buffers 305. In one embodiment, a buffer may be associated with procedural memory 313 and declarative memory 315 and thus be used for holding the current procedure and one for holding information retrieved from the declarative memory 315.

The integration of the various systems of the ACT-R framework 301 may include three directions of communication with the auxiliary symbolic network 323 and the neural network 321. A first direction may be the knowledge to memory. The symbolic module 323 may include background knowledge graphs (KG) or domain KGs. The symbolic module 323 may also include a lexical resources (LR), rule bases (RB), and a suitable inference engine, etc. The symbolic module 323 may be linked to the declarative memory 315. There may be a two-way integration between the symbolic module as it can be read or written by ACT-R. The written operation may be triggered when populating or pruning world knowledge may be needed as part of a task-execution.

Another direction may be the neural to perception. The neural module 321 may include a neural network. The neural network 321 may include a convolutional neural network, recurrent neural network, long-short-term memory network, etc. The neural network 321 may be trained and tested with raw data processed from the environment. The network 321 may provide relevant patterns of information to the perceptual module 303. The integration may bypass the direction connection holding found in a standard ACT-R system that is present in between the perceptual module 303 and the environment 319.

In the knowledge to neural network direction, the embedding mechanisms may govern knowledge-infusion in the neural network 321. The system may enable knowledge-based contextualization of patterns of information distilled from the environment and utilize it as input for the ACT-R's perceptual module 303.

If the mutual connections between the two proposed modules and ACT-R provide comprehensive knowledge structures along with scalable learning functionalities, they don't—per se—bring about high-level reasoning: this capability emerges from two features of the integrated framework, namely the cognitive architecture's own procedural module and the inference engine in the external symbolic module.

The procedural module 303 may match the content of the other module buffers 305 and coordinates their activity using production rules, which may be ‘condition-action’ pairs tied to the task at hand. Productions may use a utility-based computation to select, from a set of task-specific plausible rules, the single rule that is executed at any point in time. For instance, when building a recommendation system to support a mechanic in troubleshooting a car engine, a relevant scenario that needs to be covered is a vehicle that doesn't start but has power. In such an example, a high-utility production rule may capture the following heuristic: if the engine holds compression well, and the fuel system is working correctly, then check the spark plugs. Data indicating such may be utilized in the system. The conditions in this rule clearly require empirical evidence, as it is often the case when cognitive architectures are applied to real-world problems: in our scenario, such evidence could be actually gathered by a real technician using the recommendation system in a human-machine-teaming fashion, a type of application that would fall under the ‘cognitive model as oracle’ paradigm.

The inference engine in the symbolic module may be used to derive knowledge from assertions in the semantic resource of reference, a well-known feature of symbolic AI systems. What may be important, is that—in the embodiments described herein—this form of logic-based reasoning may have two functions: (1) providing a combination of asserted and inferred knowledge that the cognitive architecture (e.g., ACT-R) declarative memory can process and pass to the production system; and (2) supporting knowledge-infusion into neural modules. In particular, the first functionality helps to decouple basic forms of reasoning, e.g. temporal and spatial, from cognitive assessments performed by the production system on conditional actions. Such features may make the proposed system efficient, as ACT-R productions may not be well-suited for logical reasoning.

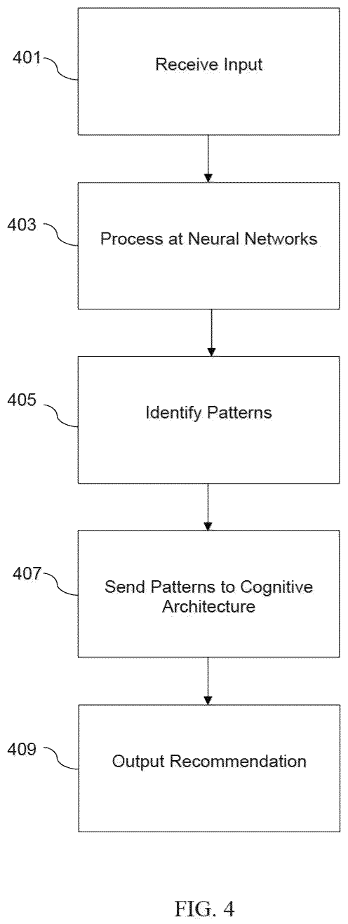

FIG. 4 is an embodiment of a flow chart of processing input to obtain an output utilizing a system according to one embodiment, such as that described in FIG. 3 above. A first step at 401 is that the system may receive an input data. The input data may include a scene that has a vast amount of data utilized by the system. Such data may include video, audio, language (e.g., text) and other information to describe a scene or environment.

At step 403, the input data may be fed into a neural network for processing. The neural network may be a CNN, RNN, or LSTM. The data may be fed until a convergence threshold is met or approached. The data may be analyzed for classifications of the data to identify a scene or environment. For example, the data may be individually analyzed to determine a sound classification. Thus, the audio data may be analyzed. The video data may be identified for classification of the image or images. The language data may also be analyzed to identify a request, or context of the area. In some scenarios the language may include a question or request.

At step 405, the system may identify patterns utilizing the classifications. The system may identify semantic observations from the raw data and create labels. The labels may be utilized to identify events or textual descriptions. An embedding method may be used to infuse semantic structures into the neural network, thus augmenting the identified patterns with context-based knowledge.

At step 407, the patterns may be output from the neural network to the cognitive architecture. Through suitable modular processing orchestrated by a central goal buffer, rule bodies in the production system are matched with patterns and assessed through utility-based functions. The rule with the highest utility value may be selected and utilized.

At step 409, the system may output a recommendation. The recommendation may be processed by the cognitive architecture with the aid of the neural network and the symbolic module. The recommendation may be distilled from the rule head of the rule whose body matches the above mentioned patterns.

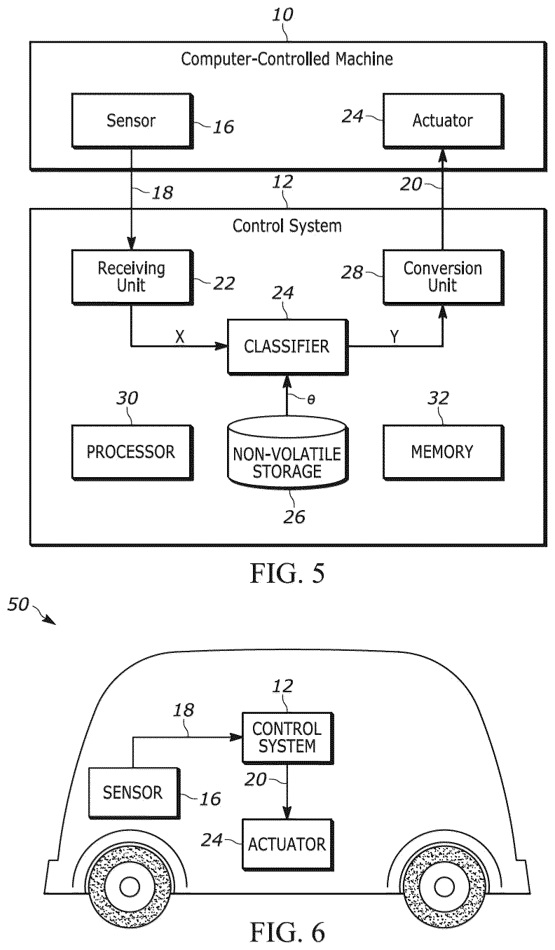

FIG. 5 depicts a schematic diagram of an interaction between computer-controlled machine 10 and control system 12. The computer-controlled machine 10 may include a neural network as described above, such as a network that includes a score prediction network. The computer-controlled machine 10 includes actuator 14 and sensor 16. Actuator 14 may include one or more actuators and sensor 16 may include one or more sensors. Sensor 16 is configured to sense a condition of computer-controlled machine 10. Sensor 16 may be configured to encode the sensed condition into sensor signals 18 and to transmit sensor signals 18 to control system 12. Non-limiting examples of sensor 16 include video, radar, LiDAR, ultrasonic and motion sensors. In one embodiment, sensor 16 is an optical sensor configured to sense optical images of an environment proximate to computer-controlled machine 10.

Control system 12 is configured to receive sensor signals 18 from computer-controlled machine 10. As set forth below, control system 12 may be further configured to compute actuator control commands 20 depending on the sensor signals and to transmit actuator control commands 20 to actuator 14 of computer-controlled machine 10.

As shown in FIG. 5, control system 12 includes receiving unit 22. Receiving unit 22 may be configured to receive sensor signals 18 from sensor 16 and to transform sensor signals 18 into input signals x. In an alternative embodiment, sensor signals 18 are received directly as input signals x without receiving unit 22. Each input signal x may be a portion of each sensor signal 18. Receiving unit 22 may be configured to process each sensor signal 18 to product each input signal x. Input signal x may include data corresponding to an image recorded by sensor 16.

Control system 12 includes classifier 24. Classifier 24 may be configured to classify input signals x into one or more labels using a machine learning (ML) algorithm, such as a neural network described above. The input signal x may include sound information. Classifier 24 is configured to be parametrized by parameters, such as those described above (e.g., parameter θ). Parameters θ may be stored in and provided by non-volatile storage 26. Classifier 24 is configured to determine output signals y from input signals x. Each output signal y includes information that assigns one or more labels to each input signal x. Classifier 24 may transmit output signals y to conversion unit 28. Conversion unit 28 is configured to covert output signals y into actuator control commands 20. Control system 12 is configured to transmit actuator control commands 20 to actuator 14, which is configured to actuate computer-controlled machine 10 in response to actuator control commands 20. In another embodiment, actuator 14 is configured to actuate computer-controlled machine 10 based directly on output signals y.

Upon receipt of actuator control commands 20 by actuator 14, actuator 14 is configured to execute an action corresponding to the related actuator control command 20. Actuator 14 may include a control logic configured to transform actuator control commands 20 into a second actuator control command, which is utilized to control actuator 14. In one or more embodiments, actuator control commands 20 may be utilized to control a display instead of or in addition to an actuator.

In another embodiment, control system 12 includes sensor 16 instead of or in addition to computer-controlled machine 10 including sensor 16. Control system 12 may also include actuator 14 instead of or in addition to computer-controlled machine 10 including actuator 14.

As shown in FIG. 5, control system 12 also includes processor 30 and memory 32. Processor 30 may include one or more processors. Memory 32 may include one or more memory devices. The classifier 24 (e.g., ML algorithms) of one or more embodiments may be implemented by control system 12, which includes non-volatile storage 26, processor 30 and memory 32.

Non-volatile storage 26 may include one or more persistent data storage devices such as a hard drive, optical drive, tape drive, non-volatile solid-state device, cloud storage or any other device capable of persistently storing information. Processor 30 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 32. Memory 32 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 30 may be configured to read into memory 32 and execute computer-executable instructions residing in non-volatile storage 26 and embodying one or more ML algorithms and/or methodologies of one or more embodiments. Non-volatile storage 26 may include one or more operating systems and applications. Non-volatile storage 26 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 30, the computer-executable instructions of non-volatile storage 26 may cause control system 12 to implement one or more of the ML algorithms and/or methodologies as disclosed herein. Non-volatile storage 26 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 12 configured to control vehicle 50, which may be an at least partially autonomous vehicle or an at least partially autonomous robot. As shown in FIG. 5, vehicle 50 includes actuator 14 and sensor 16. Sensor 16 may include one or more video sensors, radar sensors, ultrasonic sensors, LiDAR sensors, and/or position sensors (e.g. GPS). One or more of the one or more specific sensors may be integrated into vehicle 50. Alternatively or in addition to one or more specific sensors identified above, sensor 16 may include a software module configured to, upon execution, determine a state of actuator 14. One non-limiting example of a software module includes a weather information software module configured to determine a present or future state of the weather proximate vehicle 50 or other location.

Classifier 24 of control system 12 of vehicle 50 may be configured to detect objects in the vicinity of vehicle 50 dependent on input signals x. In such an embodiment, output signal y may include information characterizing the vicinity of objects to vehicle 50. Actuator control command 20 may be determined in accordance with this information. The actuator control command 20 may be used to avoid collisions with the detected objects.

In embodiments where vehicle 50 is an at least partially autonomous vehicle, actuator 14 may be embodied in a brake, a propulsion system, an engine, a drivetrain, or a steering of vehicle 50. Actuator control commands 20 may be determined such that actuator 14 is controlled such that vehicle 50 avoids collisions with detected objects. Detected objects may also be classified according to what classifier 24 deems them most likely to be, such as pedestrians or trees. The actuator control commands 20 may be determined depending on the classification. The control system 12 may utilize the system to help train the network for certain scenarios and conditions, such as during poor lighting conditions or poor weather conditions of the vehicle environment.

In other embodiments where vehicle 50 is an at least partially autonomous robot, vehicle 50 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 20 may be determined such that an electric drive, propulsion unit, steering unit and/or brake unit of the mobile robot may be controlled such that the mobile robot may avoid collisions with identified objects.

In another embodiment, vehicle 50 is an at least partially autonomous robot in the form of a gardening robot. In such embodiment, vehicle 50 may use an optical sensor as sensor 16 to determine a state of plants in an environment proximate vehicle 50. Actuator 14 may be a nozzle configured to spray chemicals. The vehicle 50 may be operate and move based on an electrical drive. Depending on an identified species and/or an identified state of the plants, actuator control command 20 may be determined to cause actuator 14 to spray the plants with a suitable quantity of suitable chemicals.

Vehicle 50 may be an at least partially autonomous robot in the form of a domestic appliance. Non-limiting examples of domestic appliances include a washing machine, a stove, an oven, a microwave, or a dishwasher. In such a vehicle 50, sensor 16 may be an optical sensor configured to detect a state of an object which is to undergo processing by the household appliance. For example, in the case of the domestic appliance being a washing machine, sensor 16 may detect a state of the laundry inside the washing machine. Actuator control command 20 may be determined based on the detected state of the laundry.

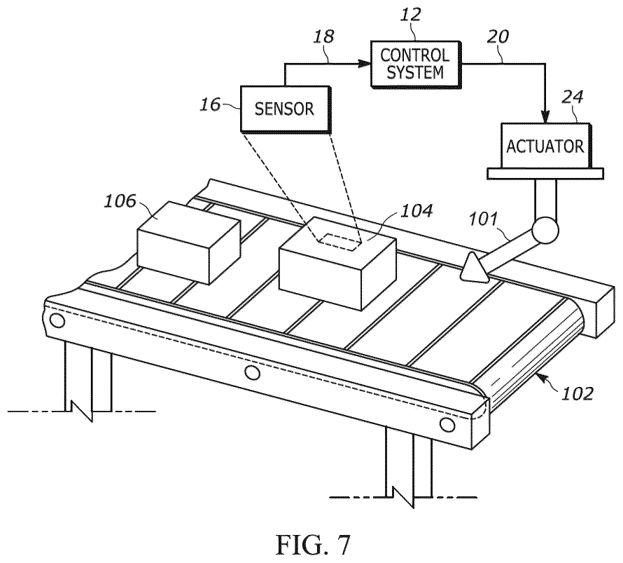

FIG. 7 depicts a schematic diagram of control system 12 configured to control system 101 (e.g., manufacturing machine), such as a punch cutter, a cutter or a gun drill, of manufacturing system 102, such as part of a production line. Control system 12 may be configured to control actuator 14, which is configured to control system 101 (e.g., manufacturing machine).

Sensor 16 of system 101 (e.g., manufacturing machine) may be an optical sensor configured to capture one or more properties of manufactured product 104 or the sensor may be an accelerometer. Classifier 24 may be configured to determine a state of manufactured product 104 from one or more of the captured properties. Actuator 14 may be configured to control system 101 (e.g., manufacturing machine) depending on the determined state of manufactured product 104 for a subsequent manufacturing step of manufactured product 104. The actuator 14 may be configured to control functions of system 101 (e.g., manufacturing machine) on subsequent manufactured product 106 of system 101 (e.g., manufacturing machine) depending on the determined state of manufactured product 104. The control system 12 may utilize the system to help train the machine learning network for adversarial conditions associated with noise utilized by the actuator or an electric drive, such as mechanical failure with parts associated with the production line.

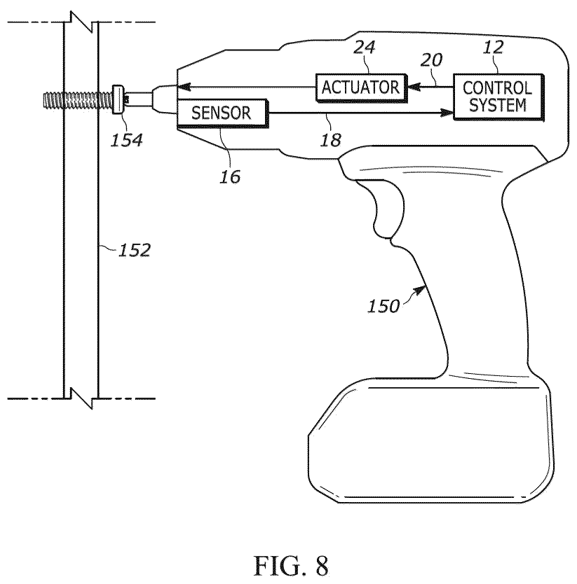

FIG. 8 depicts a schematic diagram of control system 12 configured to control power tool 150, such as a power drill or driver, that has an at least partially autonomous mode. Control system 12 may be configured to control actuator 14, which is configured to control power tool 150. The actuator may be driven by a motor or an electrical drive train. The actuator may emit a sound, as well as the motor or the electrical drive.

Sensor 16 of power tool 150 may be an optical sensor configured to capture one or more properties of work surface 152 and/or fastener 154 being driven into work surface 152. The classifier 24 may be utilized to classify a sound associated with the operation of the tool. Additionally, the classifier 24 may be configured to determine a state of work surface 152 and/or fastener 154 relative to work surface 152 from one or more of the captured properties. The state may be fastener 154 being flush with work surface 152. The state may alternatively be hardness of work surface 152. Actuator 14 may be configured to control power tool 150 such that the driving function of power tool 150 is adjusted depending on the determined state of fastener 154 relative to work surface 152 or one or more captured properties of work surface 152. For example, actuator 14 may discontinue the driving function if the state of fastener 154 is flush relative to work surface 152. As another non-limiting example, actuator 14 may apply additional or less torque depending on the hardness of work surface 152. The control system 12 may utilize the system to help train the machine learning network for certain conditions, such as during poor lighting conditions or poor weather conditions. Thus, the control system 12 may be able to identify environment conditions of the power tool 150.

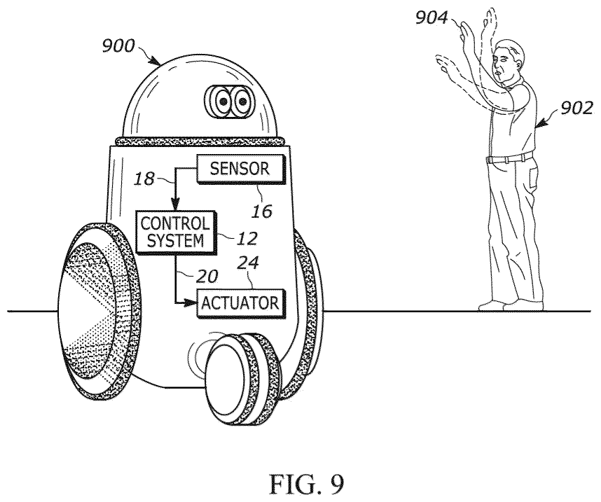

FIG. 9 depicts a schematic diagram of control system 12 configured to control automated personal assistant 900. Control system 12 may be configured to control actuator 14, which is configured to control automated personal assistant 900. Automated personal assistant 900 may be configured to control a domestic appliance, such as a washing machine, a stove, an oven, a microwave or a dishwasher. Sensor 16 may be an optical sensor and/or an audio sensor such as a microphone. The optical sensor may be configured to receive video images of gestures 904 of user 902. The audio sensor may be configured to receive a voice command of user 902.

Control system 12 of automated personal assistant 900 may be configured to determine actuator control commands 20 configured to control system 12. Control system 12 may be configured to determine actuator control commands 20 in accordance with sensor signals 18 of sensor 16. Automated personal assistant 900 is configured to transmit sensor signals 18 to control system 12. Classifier 24 of control system 12 may be configured to execute a gesture recognition algorithm to identify gesture 904 made by user 902, to determine actuator control commands 20, and to transmit the actuator control commands 20 to actuator 14. The actuator may be driven by an electrical drive train machine. Classifier 24 may be configured to sound in response to the drive train activating the actuator and to output the retrieved sound information in a form suitable for reception by user 902. The control system 12 may utilize the classifier to help train the machine learning network for various recommendations for the automated personal assistant to provide to users. Thus, the control system 12 may be able to provide improved recommendations in a specific environment in such a scenario.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method, comprising:
receiving, at a neural network, input data indicating at least video data, audio data, and natural language data;
in response to meeting a convergence threshold of the neural network utilizing the input data, outputting, via the neural network, one or more patterns associated with the input data to a cognitive architecture that includes procedural memory and declarative memory, wherein the cognitive architecture is in communication with a symbolic network that includes a knowledge graph database, wherein the symbolic network is configured to identify contextual information of the one or more patterns utilizing at least the knowledge graph database;
in response to the symbolic framework communicating the contextual information with the neural network, embedding the contextual information of the knowledge graph dataset within the neural network; and
via the neural network embedded with the contextual information, outputting a recommendation indicating information associated with at least the input data.

2. The computer-implemented method of claim 1, wherein the neural network includes a convolutional neural network, recurrent neural network, or long-short-term memory neural network.

3. The computer-implemented method of claim 1, wherein the patterns include semantic abstractions associated with the input data.

4. The computer-implemented method of claim 1, wherein the patterns include labels associated with events of the input data.

5. The computer-implemented method of claim 1, wherein the patterns include textual descriptions associated with the input data.

6. The computer-implemented method of claim 1, wherein the neural network communicates with a perceptual module associated with adaptive control of thought rational framework.

7. The computer-implemented method of claim 1, wherein the symbolic framework is configured to be read or written by the cognitive architecture.

8. The computer-implemented method of claim 1, wherein the input data is indicative of a scene.

9. The computer-implemented method of claim 1, wherein the cognitive architecture is an adaptive control of though rational (ACT-R) architecture.

10. A computer-implemented method, comprising:
receiving, at a neural network, input data indicating at least video data and natural language data;
in response to meeting a convergence threshold of the neural network utilizing the input data, outputting one or more patterns associated with the input data to a cognitive architecture, wherein the cognitive architecture is in communication with a symbolic framework that includes a knowledge graph database and the symbolic framework is configured to identify contextual information of the one or more patterns received from the neural network utilizing at least the knowledge graph database;
in response to the symbolic framework communicating the contextual information with the neural network, embedding the neural network with the contextual information of the knowledge graph dataset to yield an embedded neural network; and
outputting a recommendation indicating information associated with at least the input data utilizing the embedded neural network.

11. The method of claim 10, wherein the cognitive architecture is an adaptive control of though rational (ACT-R) architecture including both procedural memory and declarative memory.

12. The method of claim 10, wherein the symbolic framework includes a lexical resources (LR), rule bases (RB), or a suitable inference engine.

13. The method of claim 10, wherein the cognitive architecture includes procedural module configured to match content of one or more buffers.

14. The method of claim 10, wherein the cognitive architecture includes procedural module configured to coordinate one or more activities using production rules.

15. The method of claim 10, wherein the input data further includes audio data.

16. The method of claim 10, wherein the cognitive architecture is further in communication with a large language model.

17. A system, comprising:
a neural network;
a cognitive architecture;
symbolic framework; and
one or more processors, wherein the processor is programmed to:
receive, at the neural network, input data indicating at least video data, audio data, and natural language data;
in response to meeting a convergence threshold of the neural network utilizing the input data, output one or more patterns associated with the input data to the cognitive architecture including procedural memory and declarative memory, wherein the cognitive architecture is in communication with the symbolic framework that includes a knowledge graph database, wherein the symbolic framework is configured to identify contextual information of the one or more patterns utilizing at least the knowledge graph database; and
in response to the symbolic framework communicating the contextual information with the neural network, embedding of the neural network with the contextual information of the knowledge graph dataset to yield an embedded neural network, and outputting a recommendation indicating information associated with at least the input data utilizing the embedded neural network.

18. The system of claim 17, wherein the cognitive architecture is an adaptive control of though rational (ACT-R) architecture including both procedural memory and declarative memory.

19. The system of claim 18, wherein the procedural memory is configured to store data indicating facts.

20. The system of claim 18, wherein the declarative memory is configured to store data indicating rules.
